(19) United States
(12) Patent Application Publication
(10) Pub. No.: US 2023/0405542 A1
(43) Pub. Date: Dec. 21, 2023

(54) RUBIDIUM HALIDE COLLOIDAL NANOCRYSTALS

(71) Applicant: Nanyang Technological University, Singapore (SG)

(72) Inventors: Parth VASHISHTHA, Singapore (SG); Subodh Gautam MHAISALKAR, Singapore (SG); Nripan MATHEWS, Singapore (SG); Timothy John WHITE, Singapore (SG)

(21) Appl. No.: 18/033,919

(22) PCT Filed: Oct. 22, 2021
(86) PCT No.: PCT/SG2021/050645

§ 371 Date: Apr. 26, 2023

(30) Foreign Application Priority Data
Oct. 28, 2020 (SG) 10202010687T

(51) Int. Cl. B01J 13/00; C09K 11/61; C01G 3/00

(52) U.S. Cl. CPC B01J 13/0026; C09K 11/616; C01G 3/006; C01P 2002/72; C01P 2002/85; C01P 2006/60; C01P 2004/03; C01P 2004/04; C01P 2004/32; C01P 2004/64; C01P 2002/86

(57) ABSTRACT

A colloid comprising a plurality of nanocrystals, each nanocrystal comprising rubidium, a group 11 element of the Periodic Table of Elements such as copper, silver or gold, and a halogen. A method for preparing said colloid via a room temperature ligand assisted re-precipitation (LAPP) method, wherein the ligand is an acidic ligand such as oleic acid. The precursor solution is formed in a polar organic solvent such as DMSO or DMF, and the precursor solution is contacted with a non-polar organic solvent and said ligand to precipitate the nanocrystals. A polymer comprising a plurality of nanocrystals, each nanocrystal having a particle size in the range of 1 nm to 50 nm; and a use of said colloid in optoelectronic devices, etc. are also disclosed.

### CROSS-REFERENCE TO RELATED APPLICATION

This application claims the benefit of priority of Singapore Patent Application No. 10202010687T filed on 28 Oct. 2020, the contents of it being hereby incorporated by reference in its entirety for all purposes.

### TECHNICAL FIELD

The present invention relates to a colloid comprising a plurality of nanocrystals, each nanocrystal comprising rubidium, a group 11 element of the Periodic Table of Elements, and a halogen, a method for preparing the same and use for the same.

### BACKGROUND ART

Semiconductor nanocrystals offer several advantages over their bulk counterparts due to quantum confinement which results in improved photoluminescence quantum yield (PLQY), narrow emission line-width, surface functionality, and size tuneable emission wavelength. In the last decade, significant efforts have been made to not only improve the synthesis of nanocrystals but also to find novel nanocrystals with desirable optical properties. Among them, metal halide perovskite nanocrystals, such as CsPbX₃, MAPbX₃, FAPbX₃ (FA=formamidinium, MA=methylammonium, X=Cl, Br, I), have emerged as a new class of most promising candidates for optoelectronic applications. In particular, due to the pure inorganic structure of CsPbX₃ nanocrystals, high thermal stability can be achieved alongside their characteristic advantages of near unity PLQY and low processing cost. Therefore, research into other possible inorganic perovskite structures, such as Cs₄PbBr₆ and Rb_{y}Cs_{1-y}PbBr₃, has intensified.

However, the commercial viability of these materials are limited due to the toxicity of lead, resulting in the pursuit of lead-free nanocrystals. The most obvious alternative was stannous based perovskite nanocrystals (CsSnX₃), due to the favoured transformation of Sn²⁺ to Sn⁴⁺, these materials were found to be too unstable. Similarly, many other nanocrystals such as Cs₃Sb₂X₉, Cs₃B₂I₉, Cs₂AgInCl₆, Cs₂AgSbCl₆, and Cs₂AgBiCl₆ remain ambiguous for lighting applications.

There is therefore a need for development of a nanocrystal that overcomes or at least ameliorates, one or more of the disadvantages described above.

### SUMMARY

In an aspect, there is provided a colloid comprising a plurality of nanocrystals, each nanocrystal comprising rubidium, a group 11 element of the Periodic Table of Elements, and a halogen.

Advantageously, the nanocrystals as defined above may not comprise any lead, therefore circumventing issues associated with the toxicity of lead in conventional nanocrystals comprising lead. Further advantageously, as the nanocrystals as defined above that comprise rubidium, rubidium may confer to the nanocrystals the advantageous property of having a large band gap in the UV-region, with a large difference between excitation and emission spectra in the violet spectral region, high photoluminescence quantum yield (PLQY) and high crystallinity.

Further advantageously, colloidal nanocrystals as defined above may exhibit unique electrical and optical properties compared to bulk phase due to their strong quantum confinement, tuneable shape and size and reduced dimensionality. More advantageously, colloidal nanocrystals as defined above may have better phase purity compared to bulk phase. Advantageously, colloidal nanocrystals as defined above may offer better control over solution processing, and may be easier to embed in other matrices, such as polymers.

Advantageously, the colloidal nanocrystals may have high thermal stability up to 500° C. or up to 750° C., which may be essential for optoelectronic applications.

Further advantageously, the colloidal nanocrystals as defined above may be a UV-emitter. In addition, the colloidal nanocrystals as defined above may have a high PLQY, even up to 100% without any post-treatment. The high PLQY may be due to the presence of particular surface ligands in combination with the particular composition of the nanocrystals as defined above, being able to passivate any defects on the surface of the nanocrystals, thereby allowing for most or all or the photons absorbed to be emitted. Advantageously, the colloidal nanocrystals as defined above may simultaneously be a UV-emitter and have a high PLQY, while still maintaining the other advantages of colloidal nanocrystals as outlined above.

In another aspect, there is provided a method for preparing a colloid comprising a plurality of nanocrystals, each nanocrystal comprising rubidium, a group 11 element of the Periodic Table of Elements, and a halogen, the method comprising the step of mixing a first solution comprising a halide salt of rubidium and a second solution comprising a halide salt of the group 11 element of the Periodic Table of Elements, to form a precursor solution.

Advantageously, the colloidal nanocrystals may be synthesised using a room-temperature method under ambient conditions, which may make the method cost effective and scalable. Further, the method may be advantageously environmentally friendly. In addition, the method may advantageously offer flexibility in the solvents to be used in the respective solutions.

In another aspect, there is provided a nanocrystal comprising rubidium, a group 11 element of the Periodic Table of Elements, and a halogen, wherein the nanocrystal has a particle size in the range of 1 nm to 50 nm.

In another aspect, there is provided a polymer comprising a plurality of nanocrystals, each nanocrystal comprising rubidium, a group 11 element of the Periodic Table of Elements, and a halogen, wherein the nanocrystal has a particle size in the range of 1 nm to 50 nm.

In another aspect, there is provided the use of a colloid comprising a plurality of nanocrystals, each nanocrystal comprising rubidium, a group 11 element of the Periodic Table of Elements, and a halogen, in optoelectronic devices, photovoltaic cells, photodetectors, light emitting displays and air purifiers.

Advantageously, the colloidal nanocrystals may have advantageous properties as described above that make them suitable for lighting applications such as phosphor based light applications and stable light-emitting diodes (LEDs).

### Definitions

The following words and terms used herein shall have the meaning indicated:

The word “colloid” refers to a mixture in which one substance of dispersed insoluble particles (dispersed phase) are suspended throughout another substance (continuous phase). The insoluble particles may be dispersed in a liquid, aerosol or gel. The term “colloidal” should be construed accordingly.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The accompanying drawings illustrate a disclosed embodiment and serve to explain the principles of the disclosed embodiment. It is to be understood, however, that the drawings are designed for purposes of illustration only, and not as a definition of the limits of the invention.

FIG. 1 refer to spectra showing the Powder X-ray diffraction (XRD) Pattern of (a) Rb₂CuBr₃ and (b) Rb₂CuCl₃ nanocrystals with Rietveld refinement fits using TOPAS and residual maps of both graphs.

FIG. 2 refer to spectra showing the Powder X-ray diffraction (XRD) of (a) Rb₂CuBr₃ (b) Rb₂CuCl₃, and (c) Rb₂Cu(Br/Cl)₃ nanocrystals with comparison to their calculated structure of each phase present in the system.

FIG. 3 refers to the X-ray diffraction (XRD) pattern of Rb₂CuBr₃ nanocrystals recorded over 6 days with storage under ambient conditions.

FIG. 4 refers to the X-ray diffraction (XRD) pattern of Rb₂CuCl₃ nanocrystals recorded over 6 days with storage under ambient conditions.

FIG. 5 refers to graphs showing (a) Cu 2p X-ray photoelectron spectroscopy (XPS) spectra of Rb₂CuBr₃ and Rb₂CuBr₃ nanocrystals (NCs) and (b) ¹H magic-angle spinning (MAS) nuclear magnetic resonance (NMR) of Rb₂CuBr₃ and Rb₂CuCl₃ nanocrystal powders.

FIG. 6 refers to images showing the crystal structures of (a) Rb₂CuBr₃ and (b) Rb₂CuCl₃ nanocrystals with optimized lattice parameters.

FIG. 7 refers to images showing the transmission electron microscopy (TEM) micrographs of (a) Rb₂CuBr₃ and (d) Rb₂CuCl₃ nanocrystals, including high resolution TEM image of both samples depicting the lattice place of (b) Rb₂CuBr₃ and (e) Rb₂CuCl₃ nanocrystals with an inset of fast Fourier transform (FFT) images showing the crystallinity and planes of both nanocrystals sample in (b) for Rb₂CuBr₃ and (e) Rb₂CuCl₃. Particle size of both sample measured as mean diameter was estimated via an average shifted histogram of (c) Rb₂CuBr₃ and (f) Rb₂CuCl₃ nanocrystals. Scale bar for (a) and (d) are 20 nm and for (b) and (e) are 2 nm.

FIG. 8 refers to images showing the transmission electron microscopy (TEM) micrographs of (a), (b) Rb₂CuBr₃ and (d), (e) Rb₂CuCl₃ nanocrystals with histogram of (c) Rb₂CuBr₃ and (f) Rb₂CuCl₃ nanocrystals created using Fig. (b) and (e), respectively. (b) and (e) are magnified images of (a) and (d), respectively. Scale bar for (a) is 50 nm and for (b), (d) and (e) are 20 nm.

FIG. 9 refers to scanning electron microscopy (SEM) energy dispersive X-ray spectroscopy (EDXS) mapping of (a) Rb₂CuBr₃ and (b) Rb₂CuCl₃ drop casted nanocrystal solution on ITO substrate. I shows the compound, II shows Rb, III shows Cu and IV shows the halogen (Br or Cl). Scale bar for (a)(I) is 10 μm and for (a)(II) to (IV) is 25 μm, and for (b)(I) is 50 μm and (b)(II) to (IV) is 100 μm.

FIG. 10 refers to an image showing the ⁸⁷Rb magic-angle spinning (MAS) nuclear magnetic resonance (NMR) spectrum of Rb₂CuBr₃ and Rb₂CuCl₃ nanocrystal (NC) powders in comparison to pure powders of RbBr and RbCl (spinning sidebands are marked by asterisks).

FIG. 11 refers to (a) absorption spectra of Rb₂CuBr₃ and Rb₂CuCl₃ nanocrystals, and excitation dependent photoluminescence (PL) spectra of (b) Rb₂CuCl₃ nanocrystals and (c) Rb₂CuBr₃ nanocrystals. 3D PL spectra shows no peak shift as a function of excitation wavelength.

FIG. 12 refers to photoluminescence (PL) excitation and emission spectra of (a) Rb₂CuBr₃ with an inset schematic presenting the self-trapped exciton emission mechanism and (b) Rb₂CuCl₃ nanocrystals, (c) a photograph of the colloidal solution of both nanocrystals in iso-propyl alcohol under 300 nm UV lamp, and (d) thermogravimetric analysis of both samples featuring the high thermal decomposition stability.

FIG. 13 refer to graphs showing (a) power dependent photoluminescence (PL) measurement of Rb₂CuBr₃ nanocrystals embedded in polydimethylsiloxane (PDMS) polymer matrix depicting the linear dependency of PL intensity with excitation power, and (b) temperature dependent PL measurements of Rb₂CuBr₃ nanocrystals embedded in PDMS polymer matrix.

FIG. 14 refers to a graph showing normalized photoluminescence (PL) intensity as a function of time (days), while the colloidal solution of nanocrystals were stored under ambient conditions.

### DETAILED DISCLOSURE OF OPTIONAL EMBODIMENTS

There is provided a colloid comprising a plurality of nanocrystals, each nanocrystal comprising rubidium, a group 11 element of the Periodic Table of Elements, and a halogen.

Each nanocrystal may consist essentially of rubidium, a group 11 element of the Periodic Table of Elements, and a halogen.

The group 11 element of the Periodic Table of Elements may be selected from the group consisting of copper, silver and gold. The group 11 element of the Periodic Table of Elements may be copper.

The halogen may be selected from the group consisting of fluorine, chlorine, bromine, iodine and any mixture thereof.

Each nanocrystal may have a chemical composition represented by the following formula (I):

RbₓM_{y}X_{z} (I)
wherein M is the group 11 element of the Periodic Table of Elements;
X is the halogen; and
x, y and z are independently an integer between 1 and 5, as valency allows.

x, y and z may be 1, 2, 3, 4 or 5.

Each nanocrystal may have a chemical composition of Rb₂MX₃.

Each nanocrystal may be further doped with Mn³⁺.

Each nanocrystal may have a Pnma orthorhombic crystal structure.

Each nanocrystal may have a one-dimensional crystal structure consisting [CuX₄]³⁻ ribbons isolated by Rb⁺ cations. X may be the halogen.

Each nanocrystal may comprise Rb₂CuBr₃, Rb₂CuCl₃ and any mixture thereof.

Each nanocrystal may comprise Rb₂CuBr₃. Each nanocrystal may consist essentially of Rb₂CuBr₃.

Each nanocrystal may comprise Rb₂CuCl₃. Each nanocrystal may consist essentially of Rb₂CuCl₃.

The nanocrystals may display an absorption peak in the range of about 260 nm to about 270 nm, about 260 nm to 265 nm, about 265 nm to about 270 nm, about 270 nm to about 280 nm, about 270 nm to 275 nm, or about 275 nm to about 280 nm. The nanocrystal comprising Rb₂CuBr₃ may display an absorption peak at about 276 nm. The nanocrystal comprising Rb₂CuCl₃ may display an absorption peak at about 265 nm.

The nanocrystal may display a photoluminescence excitation (PLE) peak in the range of about 280 nm to about 290 nm, about 280 nm to 285 nm, or about 285 nm to about 290 nm, about 290 nm to about 295 nm, about 290 nm to about 292 nm or about 292 nm to about 295 nm. The nanocrystal comprising Rb₂CuBr₃ may display a PLE peak at about 292 nm. The nanocrystal comprising Rb₂CuCl₃ may display a PLE peak at about 285 nm.

The nanocrystal may display a photoluminescence emission (PL) peak in the range of about 385 nm to about 390 nm, about 385 nm to about 387 nm, about 387 nm to about 390 nm, about 395 nm to about 405 nm, about 395 nm to about 400 nm or about 400 nm to about 405 nm. The nanocrystal comprising Rb₂CuBr₃ may display a PL peak at about 387 nm. The nanocrystal comprising Rb₂CuCl₃ may display a PL peak at about 400 nm.

The nanocrystal may have a full-width half-maximum (fwhm) in the range of about 45 nm to about 55 nm, about 45 nm to about 48 nm, about 45 nm to about 50 nm, about 45 nm to about 52 nm, about 48 nm to about 50 nm, about 48 nm to about 52 nm, about 48 nm to about 55 nm, about 50 nm to about 52 nm, about 50 nm to about 55 nm or about 52 nm to about 55 nm. The nanocrystal comprising Rb₂CuBr₃ may have a fwhm of about 50 nm. The nanocrystal comprising Rb₂CuCl₃ may have a fwhm of about 52 nm.

The nanocrystal may have a photoluminescence quantum yield (PLQY) greater than about 40%, greater than about 45%, greater than about 48%, greater than about 60%, greater than about 70%, greater than about 80%, greater than about 90%, greater than about 95%, greater than about 98% or greater than about 99%. The nanocrystal may have a photoluminescence quantum yield (PLQY) of 100% or less than 100%. The nanocrystal comprising Rb₂CuBr₃ may have a PLQY of about 100%. The nanocrystal comprising Rb₂CuCl₃ may have a PLQY of about 49%

Each nanocrystal may have a particle size in the range of about 1 nm to about 50 nm, about 1 nm to about 2 nm, about 1 nm to about 5 nm, about 1 nm to about 10 nm, about 1 nm to about 20 nm, about 2 nm to about 5 nm, about 2 nm to about 10 nm, about 2 nm to about 20 nm, about 2 nm to about 50 nm, about 5 nm to about 10 nm, about 5 nm to about 20 nm, about 5 nm to about 50 nm, about 10 nm to about 20 nm, about 10 nm to about 50 nm or about 20 nm to about 50 nm.

Each nanocrystal may have a spherical shape.

The nanocrystals may be suspended in an organic solvent. The organic solvent may be isopropyl alcohol. The organic solvent may confer colloidal stability.

The nanocrystals may have a thermal stability up to about 500° C., about 550° C., about 600° C., about 700° C., about 750° C. or about 800° C.

There is provided a method for preparing a colloid comprising a plurality of nanocrystals, each nanocrystal comprising rubidium, a group 11 element of the Periodic Table of Elements, and a halogen, the method comprising the step of mixing a first solution comprising a halide salt of rubidium and a second solution comprising a halide salt of a group 11 element of the Periodic Table of Elements, to form a precursor solution.

The first solution and second solution may independently comprise a polar organic solvent.

The polar organic solvent may be selected from the group consisting of dimethylsulfoxide (DMSO), N,N-dimethyl formamide (DMF) and any mixture thereof.

The mixing step may be performed at room temperature or under inert atmosphere.

Room temperature may be in the range of about 20° C. to about 30° C., about 20° C. to about 22° C., about 20° C. to about 24° C., about 22° C. to about 26° C., about 22° C. to about 28° C., about 24° C. to about 26° C., about 24° C. to about 28° C., about 24° C. to about 30° C., about 26° C. to about 28° C., about 26° C. to about 30° C. or about 28° C. to about 30° C. Room temperature may be about 25° C.

An inert atmosphere may be an atmosphere consisting essentially of a nonreactive gas. The nonreactive gas may be selected from the group consisting of nitrogen, argon, carbon dioxide, helium or any mixture thereof. The nonreactive gas may be nitrogen. The inert atmosphere may consist essentially of nitrogen.

The method may comprise the step of contacting the precursor solution with a non-polar organic solvent and a ligand to precipitate the plurality of nanocrystals.

The non-polar organic solvent may be selected from the group consisting of hexane, p-xylene, toluene, benzene, ether and any mixture thereof.

The non-polar organic solvent may be miscible with the polar organic solvent.

The ligand may an organic acid. The ligand may comprise a carboxylic acid. The ligand may be selected from the group consisting of octanoic acid, oleic acid, decanoic acid and any mixture thereof.

The contacting step may comprise adding the precursor solution dropwise to a mixture of the non-polar organic solvent and the ligand with constant stirring.

The duration of the mixing step and the contacting step may be in the range of about 15 minutes to about 40 minutes, about 15 minutes to about 25 minutes, about 15 minutes to about 35 minutes, about 25 minutes to about 35 minutes, about 25 minutes to about 40 minutes or about 35 minutes to about 40 minutes.

The method for preparing a colloid as defined above may be a ligand-assisted ligand assisted re-precipitation (LARP) method. LARP may facilitate the preparation of a colloid as defined above in a very short period of time as a result of the supersaturation of all the precursors induced by the mixture of the polar organic solvent and the non-polar organic solvent.

There is provided a nanocrystal comprising rubidium, a group 11 element of the Periodic Table of Elements, and a halogen, wherein the nanocrystal has a particle size in the range of 1 nm to 50 nm.

There is provided a polymer comprising a plurality of nanocrystals, each nanocrystal comprising rubidium, a group 11 element of the Periodic Table of Elements, and a halogen, wherein the nanocrystal has a particle size in the range of 1 nm to 50 nm.

The polymer may be selected from the group consisting of polydimethylsiloxane (PDMS), poly(methyl methacrylate) (PMMA) and any mixture thereof.

The polymer may be used as a matrix to hold in place and protect the colloidal nanocrystals. The polymer may be in the form of a film or a coating.

There is provided the use of a colloid comprising a plurality of nanocrystals, each nanocrystal comprising rubidium, a group 11 element of the Periodic Table of Elements, and a halogen, in optoelectronic devices, photovoltaic cells, photodetectors, light emitting displays and air purifiers.

### EXAMPLES

Non-limiting examples of the invention will be further described in greater detail by reference to specific Examples, which should not be construed as in any way limiting the scope of the invention.

Materials

Rubidium bromide (RbBr, 99.9%, Sigma Aldrich, St. Louis, Missouri, USA). Copper(I) bromide (CuBr, 99.8%, Sigma Aldrich, St. Louis, Missouri, USA), Rubidium Chloride (RbCl, ≥99.0%, Sigma Aldrich, St. Louis, Missouri, USA), Copper(I) Chloride (CuCl, >99.995%, Sigma Aldrich, St. Louis, Missouri, USA), Dimethylsulfoxide (DMSO, Anhydrous, ≥99.0%, Sigma Aldrich, St. Louis, Missouri, USA), Isopropyl alcohol (IPA, Anhydrous, 99.5%, Sigma Aldrich, St. Louis. Missouri, USA), Toluene (Anhydrous, 99.8%, Sigma Aldrich, St. Louis, Missouri, USA), Oleic Acid (Sigma Aldrich, St. Louis, Missouri, USA).

Characterisation

X-ray diffraction (XRD) measurements were conducted by using PANalytical X-ray diffractometer equipped with a Cu Kα X-ray tube operating at accelerating voltage of 40 kV and current of 30 mA. Diffraction patterns were collected under ambient conditions using Bragg-Brentano geometry. All XRD samples were prepared by placing vacuum dried powder of nanocrystals on a zero-background holder to clearly resolve each peak.

XPS measurements were conducted using an AXIS Supra spectrometer (Kratos Analytical, U.K.) equipped with a hemispherical analyzer and a monochromatic Al Kα source (1487 eV) operating at 15 mA and 15 kV. The XPS spectra were acquired from an area of 700×300 sim with a take off angle of 90°. These measurements were undertaken on nanocrystals powder sample coated on a glass substrate. The binding energies (BEs) were charge-corrected based on the C is at 284.8 eV.

Thermal Gravimetric Analysis (TGA) measurements were performed using TA Q500 instrument. For one measurement, 5-15 mg of nanocrystals dry powder were loaded in an alumina crucibles, which was placed in a platinum pan. Each powder sample was placed inside the alumina crucibles which held by a platinum pan. Samples were measured from room temperature to 800° C. under nitrogen atmosphere and with the ramp rate of 10° C./min.

Transmission Electron Microscopy (TEM) measurements were performed by Jeol 2100F. The measurements were taken with beam current of 146 μA and accelerating voltage of 200 kV. The colloidal solution of both nanocrystals were further diluted in isopropyl alcohol before drop-casting on a holey carbon grids for the TEM analysis. Elemental analysis was performed using a Jeol 7600 FESEM at operating voltage of 20 kV. Samples were prepared by drop-casting concentrated colloidal solution of nanocrystals on an ITO coated glass substrate. In order to create histogram, 64 and 102 nanoparticles were measured for Rb₂CuBr₃, and Rb₂CuCl₃, respectively.

The photoluminescence measurements were performed using a Cary Eclipse spectrophotometer. The samples are diluted in IPA inserted in 1 cm path length quartz cuvettes. The excitation wavelengths are observed at 285 nm and 292 nm for Rb₂CuCl₃ and Rb₂CuBr₃ nanocrystals respectively, while the emission is 400 nm for Rb₂CuCl₃ and 387 nm for Rb₂CuBr₃. An excitation-dependent PL spectra were also obtained for both samples. Similar sample preparation was used for absorption spectra using a Cary 5000 UV-Vis-NIR spectrophotometer.

For time-resolved photoluminescence (TRPL) measurements, nanocrystals solution were photoexcited with 300 nm ˜50 fs pulsed laser, with 1 kHz repetition rate. The photoluminescence (PL) lifetime was measured by first collecting the PL using a lens pair, before directing the emission toward a Princeton Instrument SP2360i monochromator coupled with Optoscope streak camera. This yielded time- and spectrally resolved PL spectra. Photoluminescence quantum yield (PLQY) of both samples were measured using EXALITE 398 fluorescent dye. Later on, near unity PLQY of Rb₂CuBr₃ nanocrystals was verified using a femtosecond laser system. A Coherent LIBRA laser with output wavelength of 800 nm, repetition rate of 1 kHz, and pulse width of 50 fs was utilized. This fundamental laser light was targeted to a Coherent OPeRa Solo optical parametric amplifier (OPA), to generate tuneable wavelength output from 290-2600 nm. In the experiment, excitation source of 290 nm was used. Sample was placed inside the centre of a BaSO₄-coated 015 cm integrating sphere, before being photoexcited by the laser. The integrating sphere was connected to a monochromator and CCD using an optical fiber. The pump scattering and emission from the solvent (IPA) and sample were collected for spectrally resolved measurement. Finally, PLQY of nanocrystals was calculated by using the following formula:

$$PL QY = \frac{{\int }_{{λ}_{PL 1}}^{{λ}_{PL 2}} d λ S ( λ ) [ {I}_{sample} ( λ ) - {I}_{solvent} ( λ ) ]}{{\int }_{{λ}_{pump 1}}^{{λ}_{pump 2}} d λ S ( λ ) [ {I}_{solvent} ( λ ) - {I}_{sample} ( λ ) ]}$$

Here, S(λ) is the instrument spectral response function; Iₛₒₗᵥₑₙₜ and Iₛₐₘₚₗₑ are the intensity of collected spectra for the solvent and sample, respectively; and [λ_{PL1}, λ_{PL2}] and [λₚᵤₘₚ₁, λₚᵤₘₚ₂] are the spectral region for the sample PL and the pump, respectively.

Temperature-dependent photoluminescence spectra were measured using Fluorolog spectrofluorometer coupled with iHR550 spectrometer and CCD detector (Horiba). Sample was placed on FTIR600 heating/cooling stage (Linkam) mounted inside spectrofluorometer. The excitation wavelength was set at 292 nm.

Solid-state NMR data was acquired on a Bruker Avance III HD spectrometer utilising a Bruker 4 mm magic-angle spinning (MAS) probe. All data was referenced to the unified scale using IUPAC recommended frequency ratios and processed with the Topspin processing software. The ⁸⁷Rb MAS NMR data was completed at 14.1 T (v₀=196.40 MHz) with a spinning frequency of 14 kHz. The ⁸⁷Rb one pulse sequence utilised a selective π/6 pulse length of 1.2 μs, calibrated on RbBr₍ₛ₎, and relaxation delays of 0.5-1.2 s. The ⁸⁷Rb spin-lattice relaxation times were measured using a saturation recovery pulse sequence utilising a 200 pulse saturation pulse-train. The ¹H MAS NMR data was completed at 14.1 T (v₀=600.18 MHz) with a spinning frequency of 14 kHz. The ¹H one pulse sequence utilised a non-selective x/2 pulse length of 3.4 μs, calibrated on adamantane₍ₛ₎, and relaxation delays of 1-2 s.

### Example 1: Synthesis

Rb₂CuBn₃ and Rb₂CuCl₃ Colloidal Nanocrystals

Colloidal nanocrystals (NCs) of Rb₂CuX₃ were synthesized via a room temperature ligand assisted re-precipitation (LARP) method. In this method, the halide precursor salts of RbX (X=Cl, Br), and CuX were firstly dissolved in dimethyl sulfoxide solvent. After that, the precursor solution was added dropwise to a solution of toluene and oleic acid ligands, which resulted in the formation of the nanocrystals. After 5 minutes, the reaction was stopped, the nanocrystals were purified and finally dissolved in iso-propanol (IPA) to prepare a colloidal solution.

For Rb₂CuBr₃ synthesis, 0.8 mmol (132.30 mg) of RbBr and 0.4 mmol (57.38 mg) of CuBr were first dissolved separately in 2 ml and 1 mL DMSO solvent, respectively. After that, both solutions were mixed together to form Rb₂CuBr₃ precursor solution under a nitrogen filled glove box. 80 μL of DMSO precursor solution was added dropwise into a solution containing 5 mL toluene and 400 μL oleic acid. The nanocrystals were instantly precipitated and a white-transparent solution was obtained.

For Rb₂CuCl₃ synthesis, exact similar method was used in which, 0.8 mmol (96.74 mg) of RbCl and 0.4 mmol (39.59 mg) of CuCl were dissolved separately in 2 mL and 1 mL of DMSO, respectively. After that, both solutions were mixed together to form Rb₂CuCl₃ precursor solution under a nitrogen filled glove box. 80 μL of DMSO precursor solution was added dropwise into a solution containing 5 mL toluene and 200 μL oleic acid. The nanocrystals were instantly precipitated and a white-yellow solution was obtained.

Both nanocrystals were the purified by centrifuging at 8,000 RPM for 6 minutes. The supernatant was discarded and the precipitate was dispersed in 2 mL isopropyl alcohol for further optical and microscopy characterization. The resulting precipitate was further dried under vacuum for NMR, powder XRD, and TGA measurements.

Polymer Comprising Colloidal Nanocrystals

10:1 (w/w) of polydimethylsiloxane (PDMS) pre-polymer (1 g) and curing agent (0.1 g) from SYLGARD™ 184 Silicone Elastomer Kit (Dow Corning, Midland, Michigan, USA) were mixed with 10 mg of nanocrystal powder in 2 mL toluene and further mixed inside a petri dish. The petri-dish was then placed inside a vacuum oven to remove air bubbles and left overnight at 60° C. to cure. The resulting film contained nanocrystals embedded in the PDMS matrix.

### Example 2: Characterisation of Colloidal Nanocrystals

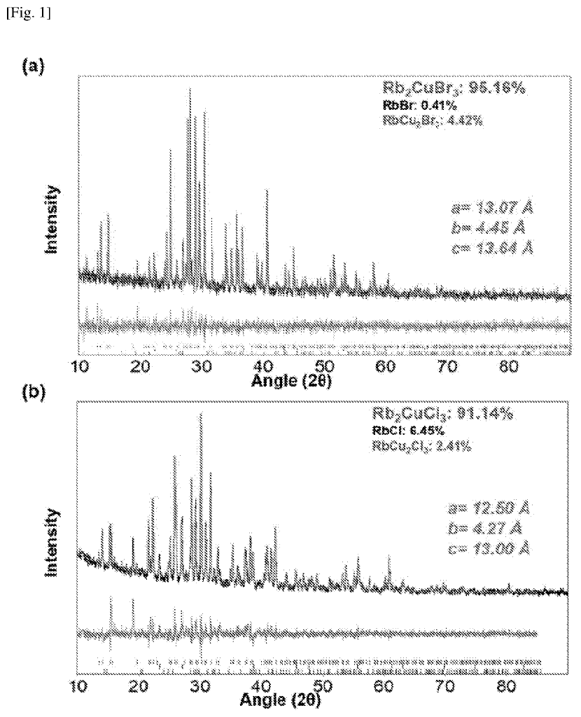

Nanocrystals were characterized using powder X-ray diffraction (XRD) to analyse the crystallographic properties. FIGS. 1(a) and 1(b) depict the diffraction pattern of Rb₂CuBr₃ and Rb₂CuCl₃ nanocrystals. Rietveld refinement using TOPAS confirmed the orthorhombic crystal structure of Rb₂CuBr₃ (Pnma) and Rb₂CuCl₃ (Pnma) with lattice parameters of a=13.0786 Å, b=4.4518 Å, c=13.6465 Å and a=12.5084 Å, b=4.2741 Å, c=13.0085 Å, respectively. The cell parameters are listed in Tables 1 and 2.

TABLE 1
Refined position coordinates for Rb₂CuBr₃ nanocrystals

| Atom | Wyck. | Occupancy | x/a | y/b | z/c |
|---|---|---|---|---|---|
| Rb1 | 4c | 1 | 0.1727 | 1/4 | 0.4750 |
| Rb2 | 4c | 1 | 0.5123 | 1/4 | 0.6761 |
| Cu1 | 4c | 1 | 0.2543 | 1/4 | 0.1896 |
| Br1 | 4c | 1 | 0.1381 | 1/4 | 0.0517 |
| Br2 | 4c | 1 | 0.4366 | 1/4 | 0.1384 |
| Br3 | 4c | 1 | 0.2755 | 1/4 | 0.7825 |

TABLE 2
Refined position coordinates for Rb₂CuBr₃ nanocrystals

| Atom | Wyck. | Occupancy | x/a | y/b | z/c |
|---|---|---|---|---|---|
| Rb1 | 4c | 1 | 0.1705 | 1/4 | 0.4743314 |
| Rb2 | 4c | 1 | 0.513412 | 1/4 | 0.6711555 |
| Cu1 | 4c | 1 | 0.2530842 | 1/4 | 0.1883719 |
| Cl1 | 4c | 1 | 0.1390 (10) | 1/4 | 0.05092 (92) |
| Cl2 | 4c | 1 | 0.43708 (90) | 1/4 | 0.13997 (99) |
| Cl3 | 4c | 1 | 0.27712 (88) | 1/4 | 0.77991 (92) |

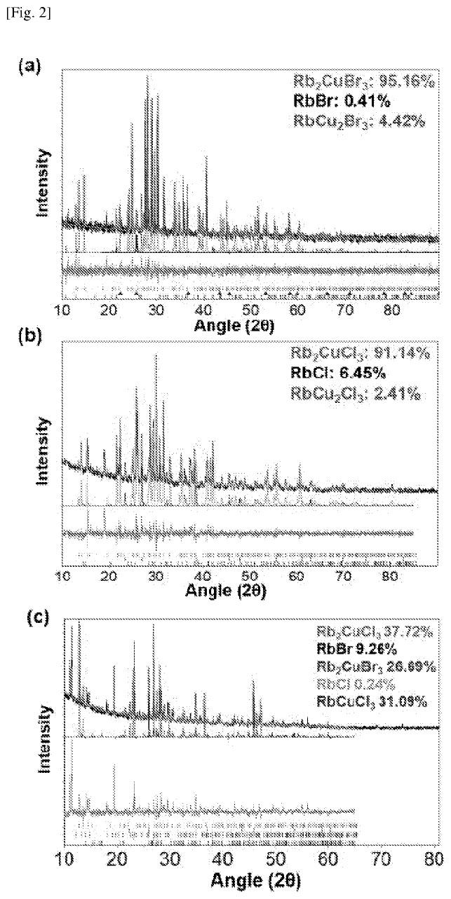

Expected peak broadening due to nanocrystallinity was not completely observed as the samples were prepared by vacuum drying nanocrystal powders to clearly observe all of the reflection for phase identification, which is also consistent with XRD patterns of other reduced dimensional copper halide colloidal nanocrystals. Additionally, Rietveld refinement revealed some phase impurity of RbBr (0.4%), and RbCu₂Br₃ (4.4%) in the Rb₂CuBr₃ sample and RbCl (6.4%), and RbCu₂Cl₃ (2.4%) in the Rb₂CuCl₃ sample. However, the total amount of impurity was less than 9% in both samples. A diagram identifying each peak individually is presented in FIG. 2. FIG. 2(a) refers to Rb₂CuBr₃, FIG. 2(b) refers to Rb₂CuCl₃, and FIG. 2(c) Rb₂Cu(Br/Cl)₃ nanocrystals with comparison to their calculated structure of each phase present in the system. As evident, the mixed halide sample exhibited several impurities, and the synthesis was not feasible using the LARP method.

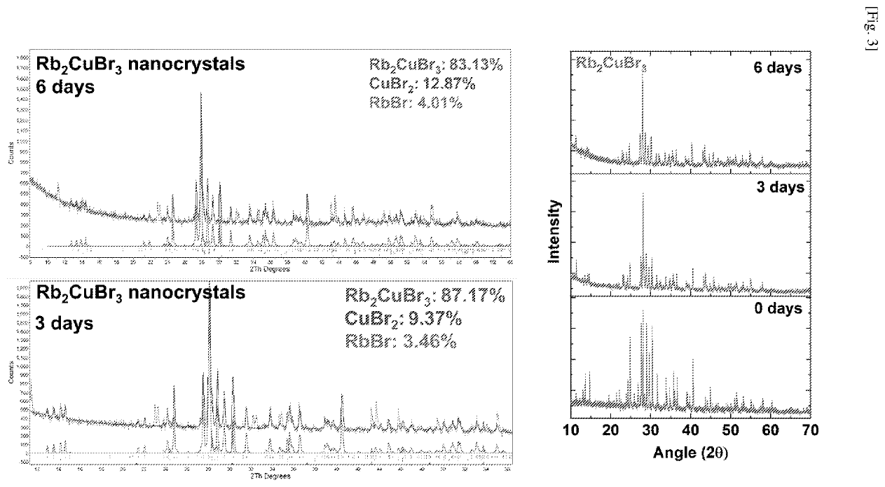

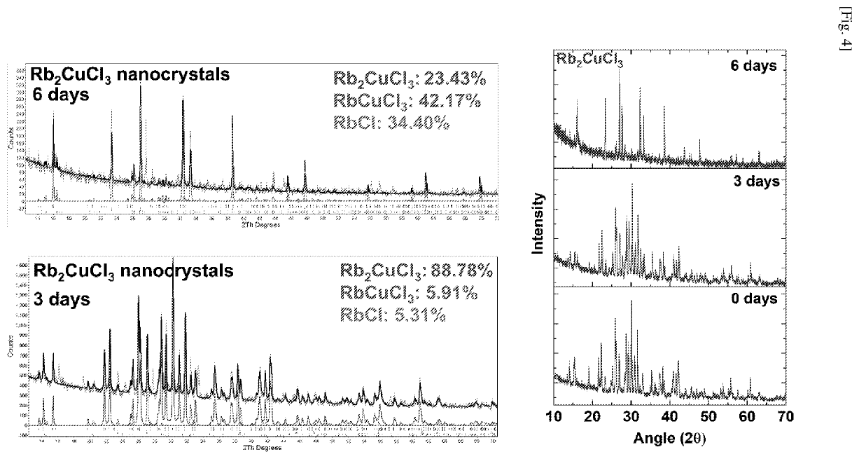

A phase degradation study over 6 days under ambient conditions using XRD on these nanocrystals explained that the Cu⁺ slowly oxidizes to Cu²⁺. It was found that within 6 days, 77% of the Rb₂CuCl₃ had slowly degraded to RbCuCl₃ (42%) and RbCl (35%); in contrast, only 17% of Rb₂CuBr₃ had degraded to CuBr₂ (13%) and RbBr (4%) over 6 days (FIG. 3, FIG. 4 and Table 3). FIG. 3 and FIG. 4 show the formation of Cu²⁺ structure such as RbCuCl₃ and CuBr₂ over time with side products of RbBr and RbCl.

TABLE 3
Phase degradation of Rb₂CuBr₃ and Rb₂CuCl₃ nanocrystal
powder under ambient conditions
Rb₂CuBr₃ nanocrystals

| Time | Rb₂CuBr₃ | RbCu₂Br₃ | | |
|---|---|---|---|---|
| (days) | (wt %) | (wt %) | RbBr (wt %) | CuBr₂ (wt %) |
| 0 days | 95.16 | 4.42 | 0.41 | — |
| 3 days | 87.17 | — | 3.46 | 9.37 |
| 6 days | 83.13 | — | 4.01 | 12.87 |

Rb₂CuCl₃ nanocrystals

| Time | Rb₂CuCl₃ | RbCu₂Cl₃ | | |
|---|---|---|---|---|
| (days) | (wt %) | (wt %) | RbCl (wt %) | RbCuCl₃ (wt %) |
| 0 days | 91.14 | 2.41 | 6.45 | — |
| 3 days | 88.78 | — | 5.31 | 5.91 |
| 6 days | 23.43 | — | 34.40 | 42.17 |

The faster degradation of Rb₂CuCl₃, in comparison to Rb₂CuBr₃, may be attributed to the higher hygroscopicity of RbCl than that of RbBr. Therefore, the degradation of these materials may be due to the absorption of moisture, which leads to the oxidation of Cu⁺ structures to Cu²⁺ structures and also the decomposition to RbBr/RbCl.

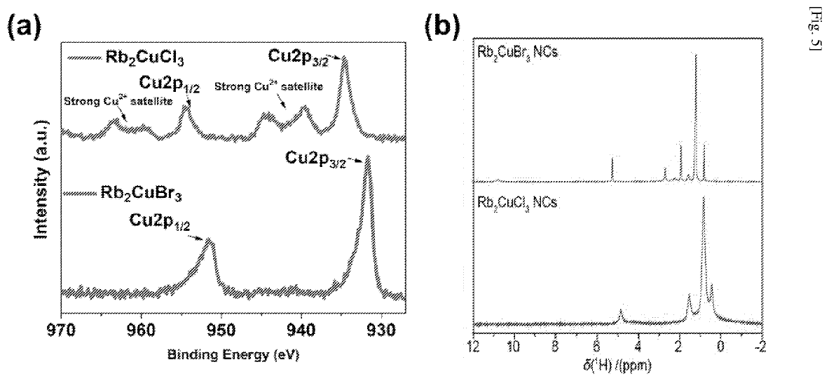

Moreover, X-ray Photoelectron Spectroscopy (XPS) study of Rb₂CuBr₃ revealed that copper core-level spectrum consists of a 2p doublet exhibiting binding energies of 931.7 eV (2p_{3/2}) and 951.5 eV (2p_{1/2}) with a separation of 19.7 eV, which is consistent with Cu⁺ (FIG. 5(a)). As evident, the Rb₂CuCl₃ sample showed some strong Cu²⁺ satellite peaks confirming the surface oxidation in this sample, which may be the cause of faster structural and photoluminescence (PL) degradation in this material,

Similarly, Cu 2p XPS spectrum for Rb₂CuCl₃ shows 2p doublet with the binding energies of 934.6 eV (2p_{3/2}) and 954.3 eV (2p_{1/2}) with a separation of 19.7 eV, corresponding to Cu⁺. However, Cu 2p XPS spectrum of Rb₂CuCl₃ also shows strong Cu²⁺ satellite peak, which indicates the surface oxidation in Rb₂CuCl₃ nanocrystals. A noticeable color change of the nanocrystal powders from white to green/yellow was observed after a few hours under ambient conditions.

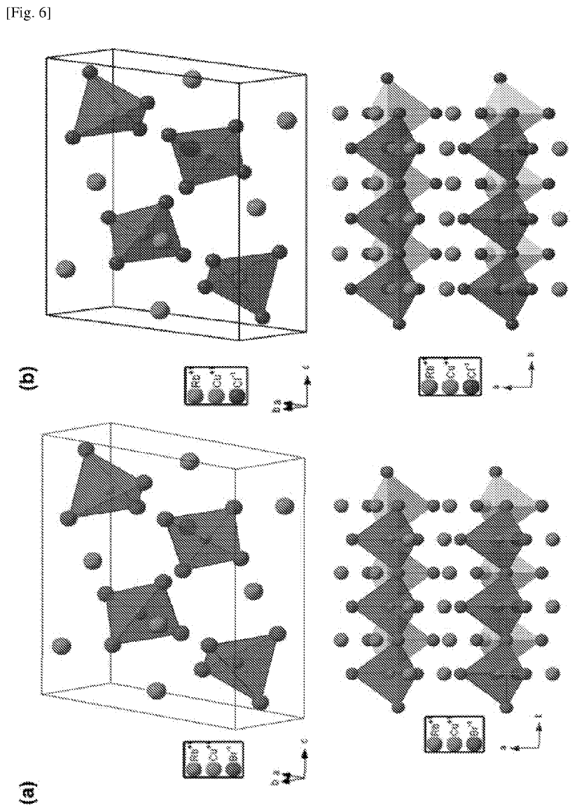

Despite being susceptible to degradation in powder form, the colloidal solution of these nanocrystals was found to be stable over a week (white colored transparent liquid). FIG. 6 shows the crystal structure of both samples. In the typical crystal structure, the Cu atom is surrounded by four bromine/chlorine atoms as a [CuX₄]³⁻ tetrahedron. As depicted in the bottom panel of FIG. 6, these tetrahedrons form a corner-sharing one dimensional chain along the <010> plane separated by Rb⁺ cations, exhibiting [CuX4]³⁻ chains isolated by Rb⁺ cations forming a one dimensional crystal structure.

The synthesis of Rb₂Cu(Br/Cl)₃ was also attempted, however the yield was small with many side products formed (FIG. 2(c)), suggesting further research is required to optimize the mixed-halide phase.

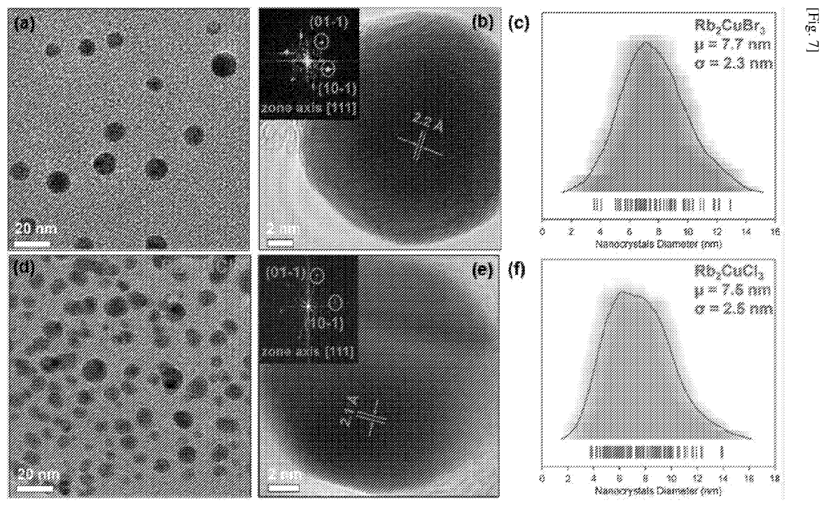

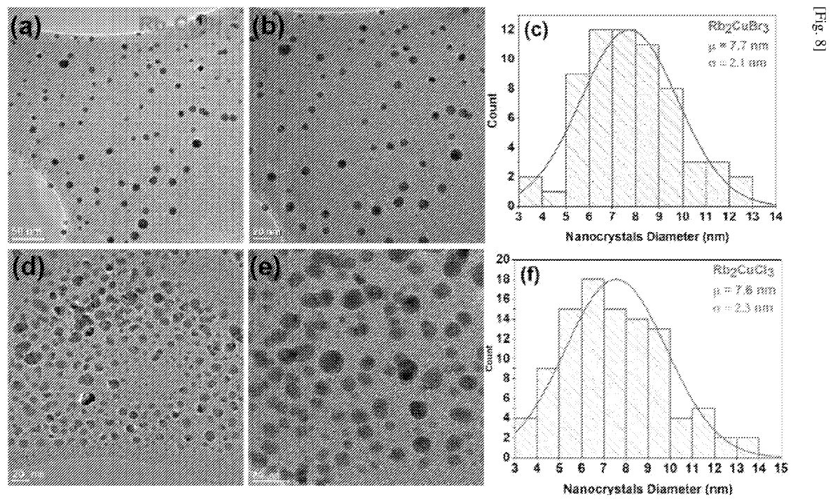

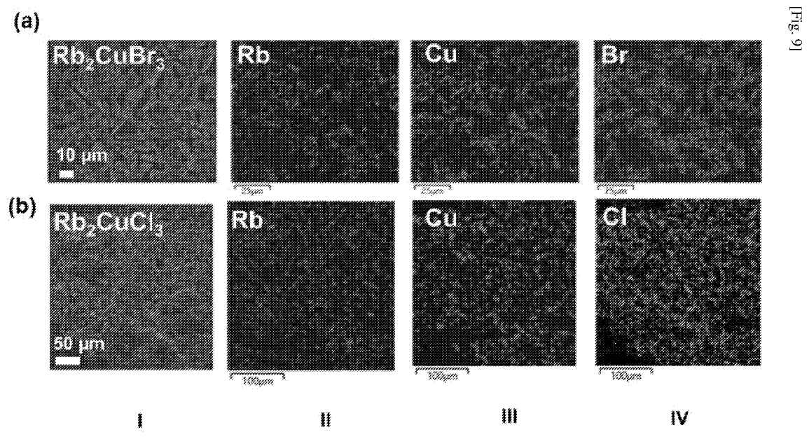

The nanocrystals were examined using transmission electron microscopy (TEM) to analyse the morphology and size. FIG. 7 depicts the TEM micrographs of Rb₂Cu₂Br₃ and Rb₂Cu₂Cl₃ nanocrystals. Both samples showed nanoplate-like faceted morphology with an average size of ˜7.7 nm for Rb₂CuBr₃ and ˜7.5 nm for Rb₂CuCl₃(FIGS. 7 and 8). An average shift histogram (FIGS. 7(c) and 7(f)) and a standard histogram (FIGS. 8(c) and 8(f)) were plotted for the illustration of particle distribution. High-resolution TEM and fast Fourier transform (FFT) (FIGS. 7(b) and 7(e)) gave lattice spacings of 2.2 Å and 2.1 Å for Rb₂CuBr₃ and Rb₂CuCl₃ nanocrystals respectively. Matching of FFT with the <020> plane of the corresponding diffraction patterns plane of both samples reverified the formation of Rb₂CuX₃ crystal structure, as confirmed by XRD. Elemental analysis, via energy dispersive x-ray spectroscopy (EDXS) revealed atomic ratios of 1.97:1.00:3.01 for Rb₂CuBr₃ and 1.96:1.00:2.95 Rb₂CuCl₃ nanocrystals (FIG. 9(a), 9(b) and Table 4). Elemental analysis confirmed the estimated ratio of 1.97:1.00:3.01 for Rb₂CuBr₃ and 1.96:1.00:2.95 for Rb₂CuCl₃ nanocrystals.

TABLE 4
EDXS data of Rb₂CuBr₃ and Rb₂CuCl₃ drop casted on ITO substrate.
Rb₂CuBr₃ Nanocrystals

| No. | Rb | Cu | Br |
|---|---|---|---|
| 1 | 35.82 | 18.16 | 54.90 |
| 2 | 35.18 | 18.10 | 53.86 |
| 3 | 35.96 | 17.98 | 54.22 |
| Mean + Std. | 35.65 ± 0.33 | 18.08 ± 0.07 | 54.32 ± 0.43 |
| deviation | | | |
| Ratio | 1.97 | 1.00 | 3.01 |

Rb₂CuCl₃ Nanocrystals

| No. | Rb | Cu | Cl |
|---|---|---|---|
| 1 | 35.90 | 18.04 | 54.06 |
| 2 | 35.34 | 17.86 | 53.58 |
| 3 | 35.66 | 18.58 | 53.18 |
| Mean + Std. | 35.63 ± 0.22 | 18.16 ± 0.30 | 53.60 ± 0.36 |
| deviation | | | |
| Ratio | 1.96 | 1.00 | 2.95 |

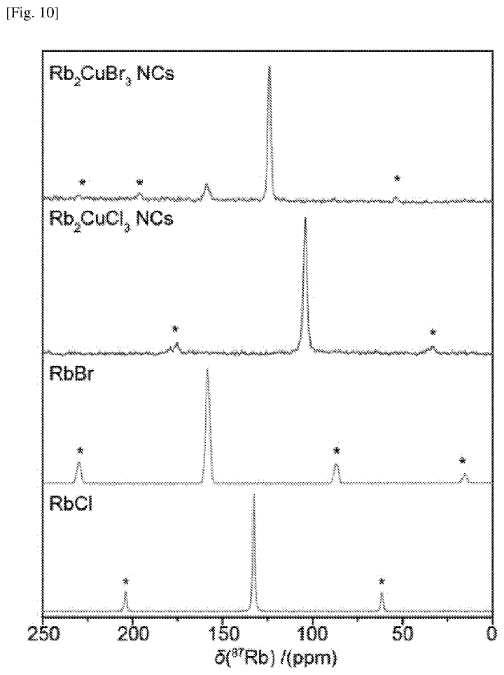

Solid state NMR was also utilized to help further characterise the nanocrystal powders. ⁸⁷Rb MAS NMR of both nanocrystal samples is shown in FIG. 10, alongside the spectra of the halide precursor salts RbBr and RbCl. The Rb₂CuBr₃ nanocrystal spectrum presents with a dominant resonance at 124 ppm assigned to the Rb₂CuBr₃ phase. A smaller resonance at 159 ppm is identical to the resonance given by the pure RbBr powder, and hence can be assigned as the RbBr impurity, detected by XRD. The ⁸⁷Rb MAS NMR of the Rb₂CuCl₃ nanocrystal sample presents a singular narrow resonance at 104 ppm. The Rb₂CuCl₃ resonance is shifted to lower frequency than the corresponding Rb₂CuBr₃ resonance which is analagous to the shift difference between RbBr and RbCl.

The narrowness of the Rb₂CuX₃ resonances demonstrates the relatively symmetrical environment about the Rb site within the channels created by the 1D [CuX⁴]³⁻ chains, as no quadrupolar effect is observed. The impurities of RbCl and RbCu₂X₃ observed in the XRD of the nanocrystal powders are presumed to have a small enough concentration that they cannot be seen above the noise in the ⁸⁷Rb spectra. In addition, the lack of any observed effect from paramagentic centres on the ⁸⁷Rb NMR, as demonstrated by the relatively unchanged ⁸⁷Rb spin-lattice relaxation times (Table 5), indirectly confirms that RbCu(II)X₃ phases are not present in the fresh powder samples. The ¹H MAS NMR of both samples (FIG. 5(b)) also reveals that the oleic acid ligands responsible for the nanocrystal formation are still present in the nanocrystal powders.

TABLE 5
⁸⁷Rb solid state NMR chemical shift (δᵢₛₒ) and spin-lattice relaxation
times (T₁) of Rb₂CuBr₃ and Rb₂CuCl₃
nanocrystals compared to RbBr and RbCl.
⁸⁷Rb NMR

| | δᵢₛₒ/ppm | T₁/s |
|---|---|---|
| Powders | (±0.5) | ±0.05) |
| Rb₂CuBr₃ | 123.5 | 0.15 |
| Rb₂CuCl₃ | 104.2 | 0.12 |
| RbBr | 158.6 | 0.23 |
| RbCl | 132.5 | 0.20 |

Collectively, XRD, TEM, EDXS, and NMR have confirmed the formation of Rb₂CuX₃ nanocrystals with an orthorhombic crystal structure and faceted nanocrystal morphology, with particle sizes less than 10 nm.

### Example 3: Optical Properties of Colloidal Nanocrystals

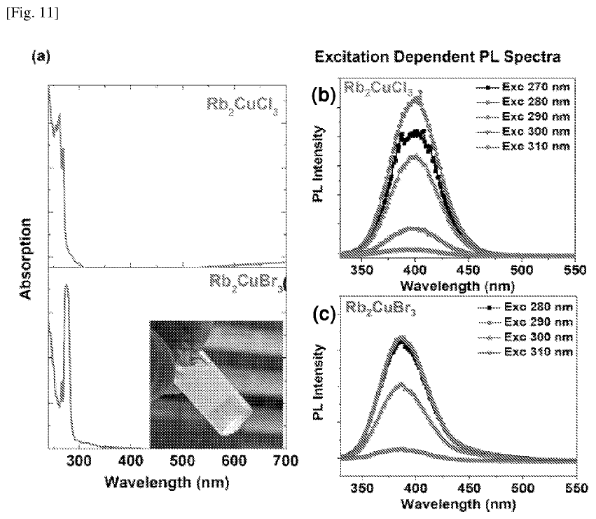

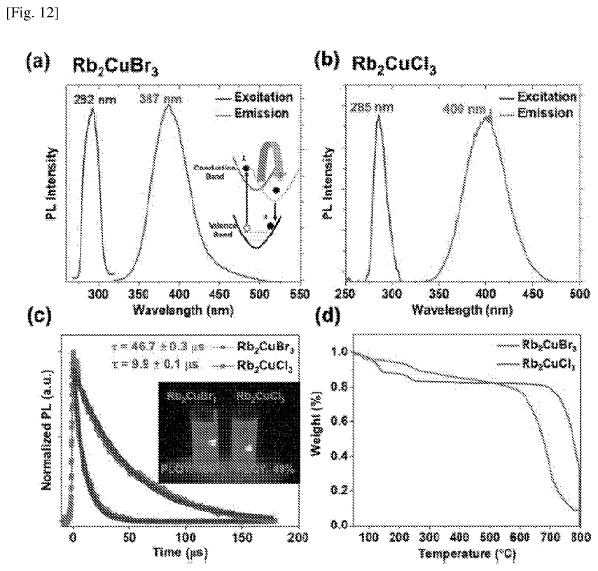

Colloidal solutions exhibit strong absorption at about 276 nm and about 265 nm respectively, which is about 20 nm blue shifted compared to the reported absorption profile of the bulk materials and single crystals (FIG. 11). Rb₂CuBr₃ and Rb₂CuCl₃ exhibits an excitation peak at 292 nm and 285 nm (FIGS. 12(a) and 12(b)), confirming that the excitation is due to the excitonic absorption. As depicted in FIGS. 12(a) and 12(b), Rb₂CuBr₃ shows an emission peak at 387 nm with full width at half maximum (fwhm) of 50 un, whereas Rb₂CuCl₃ shows an emission peak at 400 nm with a fwhm of 52 nm. These nanocrystals show extremely bright violet colour under 300 nm UV excitation (FIG. 12(c)) with PLQY of ˜100% and 49% for Rb₂CuBr₃ and Rb₂CuCl₃, respectively.

The lower PLQY of Rb₂CuCl₃ sample may be attributed to structural defects of metal chloride based materials; which has also been observed in chlorine-based perovskites. In order to confirm there is no emission from mixed phases, excitation dependent PL spectra was measured (FIGS. 11(b) and 11(c)). However no peak shift in emission spectra was observed, confirming the emission source is the main product Rb₂CuX₃ in both samples. A large Stokes shift in both nanocrystals has also been observed in previous studies of bulk materials, which suggests that the emission is not due to band-to-band emission. The excitation and emission spectral features are quite similar, which confirms that the PL originates from the relaxation of the same excited state.

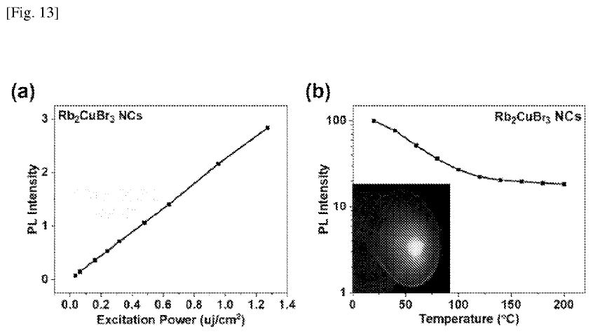

Time-resolved PL measurements were conducted to measure the carrier lifetime of these nanocrystals. As depicted in FIG. 12(c), Rb₂CuBr₃ nanocrystals exhibited a long carrier lifetime of 46.7 μs, whereas Rb₂CuCl₃ exhibited a carrier lifetime of 9.9 μs, which is consistent with their bulk counterparts. FIG. 13(a) shows the linear dependency of PL intensity with excitation power, suggesting the PL does not arise from a permanent defect. Whereas, the long carrier lifetime is due to self-trapped exciton emission mechanism in these materials. It should be noted that other copper halide systems such as Cs₃Cu₂X₅ and CsCu₂X₃ also display similar microsecond carrier lifetimes.

Moreover, it was found that these materials have very high Huang-Rhys factors, which make them more susceptible for the formation of self-trapped excitons (STEs). Under light illumination, copper halide based materials are found to undergo structural reorganization such that the Cu(I)-3d¹⁰ forms Cu(II)-3d⁹ and induces strong Jahn-Teller distortion. Overall, the energy difference between Cu(II) and Cu(I) causes the large Stokes shift. Similar large Stokes shift and STE emission mechanism have been observed in other low-dimensional materials such as Cs₂AgₓNa₁₋ₓInCl₆:Bi, Cs₃Cu₂X₅, (C₄N₂H₁₄X)₄SnX₆, C₄N₂H₁₄PbBr₄, and CsCu₂I₃. Further, due to the large Stokes shift, there is nearly no overlap between the excitation and emission spectra in these nanocrystals, making them ideal candidates for phosphor-based solid-state lighting application.

### Example 4: Stability of Colloidal Nanocrystals

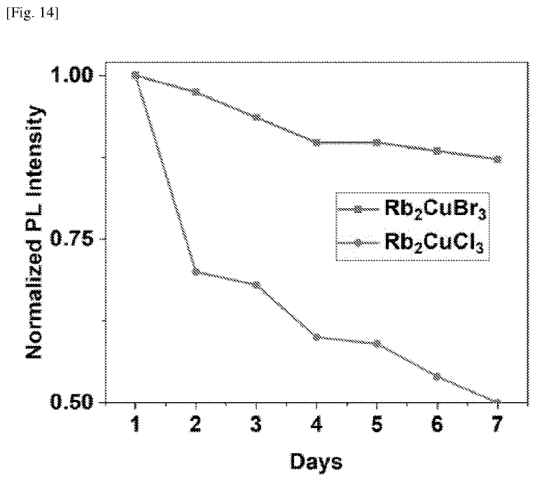

Colloidal stability of these nanocrystals was found to be reasonably stable up to 2 days in ambient conditions. Moreover, the colloidal solutions of the Rb₂CuBr₃ and Rb₂CuCl₃ nanocrystals displayed up to 13% and 50% reduction in photoluminescence quantum yield, respectively, after storage under ambient conditions (FIG. 14). Samples showed reasonable stability over 7 days under ambient condition, as only 13% of maximum PL intensity were found to be dropped for Rb₂CuBr₃ nanocrystals, whereas Rb₂CuCl₃ nanocrystals showed 50% reduction in PLQY.

The faster PL degradation in Rb₂CuCl₃ may be attributed to the surface oxidation due to high hygroscopicity of Rb₂CuCl₃ sample as observed by XPS spectra (FIG. 5(a)). These nanocrystals were successfully incorporated in PDMS polymer matrix (FIG. 13(b)), which demonstrated their compatibility to form white display devices with YAG yellow phosphor.

Materials with potential application in semiconductor devices must exhibit high thermal stability. The same nanocrystals embedded in a PDMS matrix were utilized for temperature dependent in situ PL measurements. Albeit, the temperature-dependent PL measurement showed the 50% intensity degradation at 100° C. (FIG. 13(b)), which could be due to the enhanced non-radiative recombination induced by thermal energy.

Thermal decomposition stability of the Rb₂CuX₃ nanocrystal powders, using thermal gravimetric analysis (TGA) measurements showed some promising results (FIG. 12(d)). As depicted in FIG. 12(d), weight loss up to 250° C. may be attributed to the loss of organic ligands from the surface of the nanocrystals. The TGA curve also revealed that the Rb₂CuBr₃ exhibits remarkably high thermal stability up to 750° C., 200° C. higher than the Rb₂CuCl₃ nanocrystals. Regardless, both samples show high thermal stability up to 550° C., which is desirable for optoelectronic applications.

### INDUSTRIAL APPLICABILITY

The colloid comprising a plurality of nanocrystals as defined above may have use in lighting and display applications. These colloidal nanocrystals may be combined with phosphor materials to emit pure white light. More importantly, bright UVA emission from the colloidal nanoparticles may be useful in optoelectronic devices, photovoltaic cells, photodetectors, light emitting displays, water sterilization and air purifiers.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A colloid comprising a plurality of nanocrystals, each nanocrystal comprising rubidium, a group 11 element of the Periodic Table of Elements, and a halogen.

2. The colloid according to claim 1, wherein the group 11 element of the Periodic Table of Elements is selected from the group consisting of copper, silver and gold.

3. The colloid according to claim 1, wherein the halogen is selected from the group consisting of fluorine, chlorine, bromine, iodine and any mixture thereof.

4. The colloid according to claim 1, wherein each nanocrystal has a chemical composition represented by the following formula (I):
RbₓM_{y}X_{z} (I)
wherein M is the group 11 element of the Periodic Table of Elements;
X is the halogen; and
x, y and z are independently an integer between 1 and 5, as valency allows.

5. The colloid according to claim 4, wherein each nanocrystal has a chemical composition of Rb₂MX₃.

6. The colloid according to claim 1, wherein each nanocrystal is further doped with Mn³⁺.

7. The colloid according to claim 1, wherein each nanocrystal has a Pnma orthorhombic crystal structure.

8. The colloid according to claim 1, wherein each nanocrystal has a particle size in the range of 1 nm to 50 nm.

9. The colloid according to claim 1, wherein each nanocrystal has a spherical shape.

10. The colloid according to claim 1, wherein the nanocrystals are suspended in an organic solvent.

11. A method for preparing a colloid comprising a plurality of nanocrystals, each nanocrystal comprising rubidium, a group 11 element of the Periodic Table of Elements, and a halogen, the method comprising the step of mixing a first solution comprising a halide salt of rubidium and a second solution comprising a halide salt of a group 11 element of the Periodic Table of Elements, to form a precursor solution.

12. The method according to claim 11, wherein the first solution and second solution independently comprise a polar organic solvent.

13. The method according to claim 12, wherein the polar organic solvent is selected from the group consisting of dimethylsulfoxide (DMSO), N,N-dimethyl formamide (DMF), and any mixture thereof.

14. The method according to claim 11, wherein the mixing step is performed at room temperature or under inert atmosphere.

15. The method according to claim 11, comprising the step of contacting the precursor solution with a non-polar organic solvent and a ligand to precipitate the plurality of nanocrystals.

16. The method according to claim 15, wherein the non-polar organic solvent is selected from the group consisting of hexane, p-xylene, toluene, benzene, ether and any mixture thereof, or wherein the non-polar organic solvent is miscible with the polar organic solvent.

17. (canceled)

18. The method according to claim 15, wherein the ligand is an organic acid.

19. The method according to claim 15, wherein the contacting step comprises adding the precursor solution dropwise to a mixture of the non-polar organic solvent and the ligand with constant stirring.

20. The method according to claim 15, wherein the duration of the mixing step and the contacting step is in the range of about 15 minutes to 40 minutes.

21. A nanocrystal, or a polymer comprising a plurality of said nanocrystal, wherein the nanocrystal comprises rubidium, a group 11 element of the Periodic Table of Elements, and a halogen, wherein the nanocrystal has a particle size in the range of 1 nm to 50 nm.

22. (canceled)

23. (canceled)
